(19) United States
(12) Patent Application Publication
(10) Pub. No.: US 2010/0114694 A1
(43) Pub. Date: May 6, 2010

(54) SYSTEMS AND METHODS FOR ASSOCIATION-BASED ELECTRONIC MESSAGE COMMUNICATION

(76) Inventor: Anthony D'Elia, Vero Beach, FL (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/610,805

(22) Filed: Nov. 2, 2009

Related U.S. Application Data
(63) Continuation-in-part of application No. 12/263,291, filed on Oct. 31, 2008.

(51) Int. Cl. G06Q 30/00; G06F 15/16; G06F 3/048

(52) U.S. Cl. 705/14.46; 705/14.61; 709/206; 715/246

(57) ABSTRACT

A system for association-based electronic message communication is provided. The system contemplates including advertisement databases having a plurality of advertising content representing at least one tier of advertising. The system may also include a computer system communicatively coupled to the advertisement databases and to an input mechanism. The computer system may be configured to receive information indicative of an electronic message, one or more intended recipients of the electronic message, and supplemental content. The supplemental content may be advertising content selected from the advertising content in the advertisement databases. The computer system may be also configured to format an electronic shell including the electronic message and the selected advertising content such that the electronic message is displayed with the selected advertising content. The computer system may be also configured to transmit the electronic shell to the one or more intended recipients.

This application is a continuation-in-part of U.S. patent application Ser. No. 12/263,291 filed Oct. 31, 2008. The invention relates to electronic communication in general, and to systems and methods for association-based electronic message communication, in particular.

### FIELD OF THE INVENTION

### Background of the Invention

In today's fast-paced and technology-driven world, people are spending increasing amounts of time performing on-line browsing and on-line searching, and participating in computer-based electronic communication. For example, the average American spends almost an hour each day on-line, with roughly 95% of the American population regularly participating in electronic mail (“email”) communication, and roughly 84% regularly performing on-line searching. Users worldwide exhibit similar on-line activity. Further, the onslaught of email communication for business purposes is unprecedented, and predictions indicate that there is an expected marked increase for the future. Specifically, all email communication for business purposes is expected to increase by 30% over the next four years, and the number of emails sent is expected to increase by 100%.

A key factor in the effectiveness of advertising is the degree to which the products or services offered meet the needs or interests of the audience of the advertisement. With respect to email communications, traditional approaches have employed non-targeted advertisements to unknown email recipients. These approaches are generally ineffective for a variety of reasons. For example, such emails are often filtered by software before reaching the recipient. Even such emails that are not filtered are often disregarded by the recipient when the recipient fails to recognize the sender. Given the ease of ignoring or overlooking emails, a very low percentage of the messages sent using these approaches are actually opened by the intended recipients. An even smaller percentage of opened emails are actually read or examined in any detail.

Targeted advertising using non-computer based electronic media has been used in various ways. However, electronic computer-based methods of targeted advertising have only been attempted in very limited contexts. For example, software exists to track the on-line browsing activity of a user and employ the tracked information to determine the type of advertising to target to the user. However, user privacy concerns have limited this approach. Previously, an approach that successfully directs relevant advertising via the use of email communications to a targeted group has not existed.

There is a need for electronic computer-based systems that effectively and efficiently provide relevant advertising to likely consumers while limiting unnecessary email to uninterested parties. The constituents of associations and associations often share the same goals and interests. Such shared goals and interests often correlate well with a demand for similar products and services, and in relevant information content generally. Often the shared demand for products and services is highly relevant to the particular purpose of the association or community. Accordingly, systems and methods that couple relevant information with relevant advertising and direct that information and advertising to a targeted group of constituents from a recognized source are highly desirable. Thus, it would be desirable to have a system and method that provides association-based marketing and/or information distribution via association-based electronic communication, such as email and the like.

### BRIEF SUMMARY OF THE INVENTION

In one embodiment of the invention, a system for association-based electronic message communication is provided. The system may include advertisement databases having a plurality of advertising content representing at least one tier of advertising. The system may also include a computer system communicatively coupled to the advertisement databases and to an input mechanism. The computer system may be configured to receive information indicative of an electronic message, one or more intended recipients of the electronic message, and supplemental content. The supplemental content may be advertising content selected from the advertising content in the advertisement databases. The computer system may be also configured to format an electronic shell including the electronic message and the selected advertising content such that the electronic message is displayed with the selected advertising content. The computer system may be also configured to transmit the electronic shell to the one or more intended recipients.

In another embodiment of the invention, a method of association-based electronic message communication is provided. The method may include developing an electronic communication network of one or more constituents affiliated with an association. The method may also include accumulating a plurality of advertising content from a plurality of advertisers. One or more of the advertising content may be of interest to the one or more constituents. The method may also include generating an electronic message to selected ones of the one or more constituents; and selecting supplemental content. The supplemental content may be indicative of selected advertising content from the plurality of advertising content. The selected advertising content may represent a plurality of tiers of advertising. The method may also include providing to the selected ones of the one or more constituents, an electronic shell including the electronic message and the selected advertising content. The electronic shell may be formatted to display the electronic message with the selected advertising content.

In another embodiment of the invention, an electronic shell formatted for electronic transmission is provided. The electronic shell may include a first portion including an electronic message from a sender affiliated with an association. The electronic message may pertain to a goal of the association and be intended for one or more constituents of the association. The electronic shell may also include a second portion adjacent the first portion and including supplemental content. The supplemental content may include advertising content selected independently of a content of the electronic message and based on an affiliation between the association and the one or more constituents.

In another embodiment of the invention, a method for providing a customized electronic shell is provided. The method may include receiving information indicative of one or more intended recipients of an electronic message. The method may also include receiving, at an on-line portal approved by an association with which the one or more intended recipients are affiliated, information indicative of an electronic message and supplemental content. The supplemental content may be indicative of selected advertising content. The selected advertising content may be advertisement selected from one or more advertisement databases and representing a plurality of tiers of advertising. The method may also include formatting an electronic shell, wherein the electronic shell frames at least a portion of the electronic message with the selected advertising content. The method may also include transmitting the electronic shell to the one or more intended recipients.

In another embodiment of the invention, a computer readable medium may be provided. In some embodiments, the computer readable medium includes a computer program stored on the computer readable medium and being accessed for controlling a device according to instructions of the computer program. The device may also include a receiver, a transmitter and a processor. The receiver may be controlled to receive signals indicative of an electronic message, one or more intended recipients of the electronic message, and supplemental content. The supplemental content may be advertising content selected from a plurality of advertising content in one or more advertisement databases to which the device may be communicatively coupled. The selected advertising content may represent at least one tier of advertising. In response to receiving the signals indicative of the electronic message, the one or more intended recipients, and the supplemental content, the processor of the device may be controlled to format an electronic shell including the electronic message and the selected advertising content. The electronic shell may be formatted to display the electronic message with the selected advertising content. In response to formatting the electronic shell, the transmitter of the device may be controlled to transmit to the one or more intended recipients signals indicative of the electronic shell.

In another embodiment, a system may be provided. The system may include one or more advertisement databases having a plurality of advertising content representing at least one tier of advertising. The system may also include a computer system communicatively coupled to the one or more advertisement databases and to at least two communication devices. The computer system may include a computer program having a plurality of instructions, a processor, and a computer readable medium on which the plurality of instructions are stored. The instructions may be for: receiving information indicative of an electronic message, one or more intended recipients of the electronic message; and supplemental content. The supplemental content may be advertising content selected from a plurality of advertising content in the one or more advertisement databases, wherein the selected advertising content may represent at least one tier of advertising. The instructions may be also for formatting an electronic shell including the electronic message associated with the information indicative of the electronic message and the selected advertising content associated with the information indicative of the supplemental content. The electronic shell may be formatted to display the electronic message with the selected advertising content. The instructions may be also for transmitting the electronic shell to the one or more intended recipients.

### BRIEF DESCRIPTION OF THE DRAWINGS

The purposes and scope of exemplary embodiments described below will be apparent from the following detailed description in conjunction with the appended drawings in which like reference characters are used to indicate like elements, and in which:

FIG. 1 is a schematic diagram of a system for association-based electronic message communication according to an embodiment of the invention;

FIGS. 2, 3 and 4 are screen shots of web pages for formatting an electronic shell in a system for association-based electronic message communication according to an embodiment of the invention;

FIG. 5 is a screen shot of a web page illustrating an electronic shell according to an embodiment of the invention;

FIG. 6 is a chart illustrating exemplary affiliations between associations and constituents of the associations according to an embodiment of the invention;

FIG. 7 is a flow chart of a method of operation of a system for association-based electronic message communication according to an embodiment of the invention;

FIG. 8 is a block diagram of logic of a computer system for association-based electronic message communication according to an embodiment of the invention;

FIG. 9 is a flow chart of a method of operation of a system for association-based electronic message communication according to another embodiment of the invention;

FIG. 10 is a block diagram of logic of a computer system for association-based electronic message communication according to an embodiment of the invention;

FIG. 11 is a schematic diagram of a system for association-based electronic message communication according to another embodiment of the invention; and

FIG. 12 is a block diagram of a device having a computer readable medium according to an embodiment of the invention.

### DETAILED DESCRIPTION OF THE EMBODIMENTS

It is noted that in the figures, the illustration of components as separate entities from one another is merely exemplary. The components may be combined, integrated, separated and/or duplicated to support various applications. Additionally, the schematic diagrams, screen shots and flow charts shown herein depict simplified views and may include additional or alternative blocks, logic, elements or steps that are not depicted but which remain within the spirit of the embodiments of the invention described herein.

It is also noted that although the flow charts provided herein show a specific order of method steps, it is understood that the order of these steps may differ from what is depicted. Also two or more steps may be performed concurrently or with partial concurrence. Such variation will depend on the software and/or hardware systems chosen and/or on designer choice.

It is understood that all such variations are within the scope of the exemplary embodiments. Likewise, software and/or web implementations of the exemplary embodiments could be accomplished with standard programming techniques with rule based logic and/or other logic to accomplish the various steps.

In some embodiments, the association-based electronic message communication system described herein may be any system configured to format and transmit an electronic shell including an electronic message and supplemental content having one or more tiers of advertising. In some embodiments, the system may be any system configured to format and transmit an electronic shell including an electronic message and supplemental content selected based on the recipient of the electronic message and/or the association between the sender and the recipient of the electronic message. In some embodiments, the system may be any system configured to format and transmit an electronic shell including an electronic message and supplemental content selected independently of the content of the electronic message. In some embodiments, the system may be any system configured to format and transmit an electronic shell having an electronic message and supplemental content including selected advertising content. As used herein, the term “selected advertising content” means advertising content selected manually or automatically for inclusion in an electronic shell.

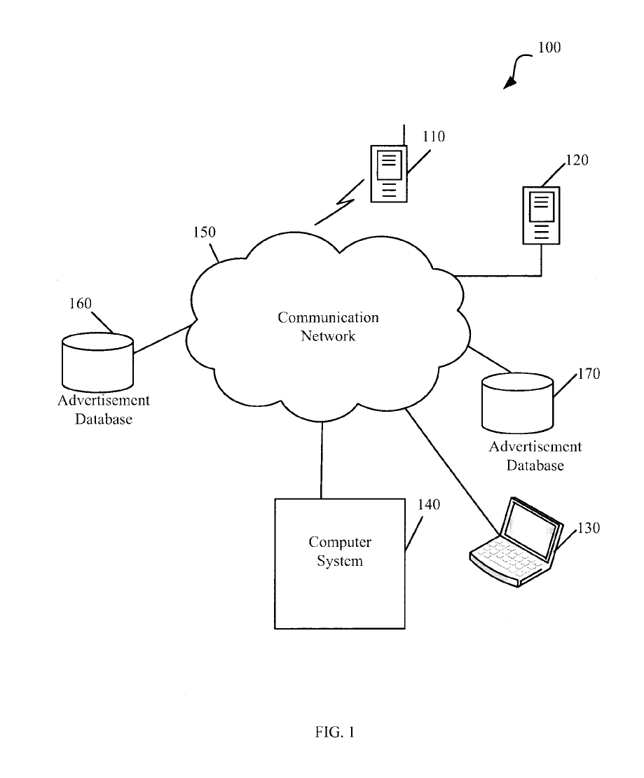

FIG. 1 is a schematic diagram of an association-based electronic message communication system according to an embodiment of the invention. As used herein, the term “electronic message” shall include any information intended to be provided from a sender to a recipient and discernable to the recipient. In various embodiments, the sender and/or the recipient may be a device and/or a user of the device. In some embodiments, the electronic message is mail and/or other content in an electronic form. In some embodiments, the electronic message may be email.

The association-based electronic message communication system 100 may include an input mechanism 110, one or more reception mechanisms 120, 130, a computer system 140, a communication network 150 and advertisement databases 160, 170. The input mechanism 110, reception mechanisms 120, 130 and computer system 140 may be communicatively coupled via the communication network 150; and the computer system 140 and the advertisement databases 160, 170 may be communicatively coupled via the communication network 150.

In some embodiments, the computer system 140 may include a web server (not shown), an electronic mail server (not shown) and/or a central computer (not shown) communicatively coupled to one another. In other embodiments, the computer system 140 may include any hardware, software logic or combination thereof configured to perform the functions described herein.

In some embodiments, the computer system 140 may receive, from the input mechanism 110, information indicative of an electronic message and supplemental content. The information indicative of the electronic message may include, in addition to a content of an electronic message, information indicative of a sender of the electronic message, or an association with which the sender is affiliated and/or information indicative of one or more intended recipients of the electronic message. As used herein, the term “supplemental content” means graphical, textual or audio static or dynamic information. By way of example, but not limitation, supplemental content may be advertising content, video content, news content, internet search content, geographical navigation content, instant messaging content, electronic map content, indicia associated with at least one or more of the intended recipients and/or an audio file.

As noted above, in some embodiments, the supplemental content may be advertising content. In one embodiment, the supplemental content may be advertising content that is stored in at least one of the advertisement databases 160, 170. The advertising content may be provided by one or more advertisers that may pay an advertising fee to have the advertising content included in the electronic shell.

In various embodiments, the advertising content may include, but is not limited to, a graphical and/or textual image and/or an audio file. By way of examples, but not limitations, a banner, an icon or any other forms of electronic advertising providing graphical and/or textual images and/or auditory sounds corresponding to audio files may be used. In some embodiments, the advertising content may be a click-through advertisement. The click-through advertisement may be associated with a first third-party web page at which a financial transaction may be initiated to purchase a product or service associated with the advertising content, and/or a web page or web site associated with the system or with another third-party. By way of example, but not limitation, the third-party web page may be a micro site affiliated with an association (e.g., sports league), while the web sites and web pages, generally, may include information related to local, regional, national, countrywide or international topics of interest including, but not limited to, community message boards, neighborhood classified advertisement information or the like.

In various embodiments, the systems and methods disclosed herein may garner a significant improvement in the rate of clicks on click-through advertisement and/or in response to the supplemental content. The response to the supplemental content may include, but is not limited to, purchasing one or more products or services associated with the supplemental content, viewing a substantial portion (e.g., 50%, more than 50%, 75%, more than 75%) of video content and/or news content, initiating a search and/or initiating a geographical navigation query. In some embodiments, the rate of clicks and/or responses may be determined as a function of the total number of electronic shells received that are opened by intended recipients. For example, the rate may be the total number of clicks or responses divided by the total number of electronic shells received that are opened by the intended recipients. By way of example, but not limitation, rates may be 10%, 15% or 20% of the total number of electronic shells received that are opened by the intended recipients. In various embodiments, 90% or 80% of the electronic shells received may be opened, and a rate of 10% of the opened electronic shells may have advertising content that is clicked and/or to which a response is made.

In various embodiments, the advertising content may represent one or more tiers of advertising. In some embodiments, a tier of advertising may be indicative of the advertising content being associated with a sponsor of the one or more intended recipients or a key advertiser of the one or more intended recipients.

As used herein, a “sponsor” means a person or entity having a focus or interest endemic to a focus or interest of an intended recipient and/or an association with which the intended recipient is affiliated. By way of example, but not limitation, a sponsor for an intended recipient that is a soccer team (or a parent of a player on a soccer team) may be the Major League Soccer® association, a sponsor for an intended recipient that is a football team (or a parent of a player on a football team) may be the National Football League association, and/or a sponsor for an intended recipient that is a potential buyer of upscale clothing may be Saks Fifth Avenue® stores. In some embodiments, the sponsor may pay a selected fee and/or provide other consideration to be a sponsor.

As used herein, a “key advertiser” means a person or entity that has paid a selected fee and/or provided consideration associated with providing advertising content in a premier manner in an electronic shell sent to one or more selected intended recipients. In some embodiments, the key advertiser may provide advertising content that includes information that is not endemic to the focus or interest of the intended recipient and/or an association with which the intended recipient is affiliated. By way of example, but not limitation, a key advertiser in an electronic shell for an intended recipient that is a football team may be an advertiser offering Aflac® insurance services, Chevy® automobiles or otherwise. By way of examples, but not limitation, the premier manner may be the display of the advertising content at a top portion of the electronic shell and/or as a flashing display and/or as an animated display.

In some embodiments, a tier of advertising may be indicative of whether the advertising content is provided by a sponsor or a key advertiser. The advertising content provided by the sponsor or the key advertiser may correspond to a first tier of revenue. In various embodiments, a first, second and/or third tier of revenue may be determined based on any number of factors. By way of example, but not limitation, the factors may include a fee or other consideration associated with the advertising content, a cost per thousand (“CPM”) impressions rate associated with the advertising content and/or a position of the advertising content on the electronic shell.

In various embodiments, the advertising content may represent one or more levels of sponsorship. In some embodiments, the electronic shell may be formatted into multiple sections and selected advertising content provided in different locations in the electronic shell based on the level of sponsorship.

In some embodiments, at least one of the levels of sponsorship may be a level wherein the selected advertising content is displayed at a top portion of the electronic shell. By way of example, but not limitation, the selected advertising content may be provided by the sponsor or the key advertiser. In one embodiment, the selected advertising content may be a banner. In some embodiments, selected advertising content corresponding to a first tier of revenue may be displayed at a top portion of the electronic shell.

In various embodiments, one or more of the levels of sponsorship may be a level wherein the selected advertising content may be displayed above or below the electronic message, below a fold of the electronic shell and/or within the body of the electronic message, in the electronic shell.

In some embodiments, the tier of advertising may be indicative of whether the selected advertising content is contextual advertising content. As used herein, “contextual advertising content” means supplemental content having other supplemental content embedded therein. By way of examples, but not limitation, contextual advertising content may be video content and/or news content having advertising content and/or a link to a web site embedded in the video content or in the news content, respectively.

In one embodiment, the contextual advertising content may include information about a product or service targeted to the recipient of the electronic message. In some embodiments, the product or service may be targeted to the recipient based on the characteristics or identity of the recipient, the affiliation between the sender of the electronic message and the recipient and/or the affiliation between an association and the recipient of the electronic message. For example, the contextual advertising content may be advertising about an article of sports equipment based on the characteristic of the recipient. In this case, the recipient may be a player on a sports team and/or a parent of a player on a sports team. In some embodiments, the contextual advertising content may include a price of the product or service. In some embodiments, contextual advertising content may correspond to a second tier of revenue.

In some embodiments, a tier of advertising may be indicative of a geographical region to which the advertising content is directed. In some embodiments, the advertising content may correspond to a third tier of revenue when the advertising content is directed to a geographical region within a proximity that is local or regional relative to the location of the recipient. For example, a product or service may be offered in a geographical region that is local to the recipient of the electronic message. In various embodiments, geographical regions in proximities that are local to the recipient may be within 5-10, 11-25 and/or 26-50 miles of the location of the recipient. In various embodiments, geographical regions in proximities that are regional to the recipient may be within 75-150, 151-250 and/or 251-400 miles of the location of the recipient.

The selected advertising content corresponding to the third tier of revenue may be displayed at a portion of the electronic shell that is below a fold in the electronic shell and/or at a bottom portion of the electronic shell. The fold of the electronic shell may be the location at a bottom of the portion of the electronic shell that is viewable by a user upon opening the electronic shell. Accordingly, in various embodiments, in order to view the portion of the electronic shell below the fold, a user may scroll down or otherwise initiate the movement of the electronic shell such that the portion below the fold is viewable to the user.

In various embodiments, the electronic message may be positioned at a location on the electronic shell such that a user will need to view a portion of the electronic shell below the fold in order to read an entirety of the content of the electronic message.

The advertising content may correspond to a first tier of revenue when the selected advertising content is directed to a geographical region within a proximity that is remote from the recipient. In various embodiments, the region may encompass a substantial portion (e.g., 75%) or an entirety of a state, nation or county in which the recipient is located. In these embodiments, the advertisement may be statewide, nationwide, countrywide and/or continent-wide.

In some embodiments, the supplemental content may be video content. The video content may include a tutorial. In some embodiments, the tutorial may include a sports practice drill, a sports formation and/or a play strategy. In some embodiments, the video content may include information about a product or service sold by an advertiser. In various embodiments, the information may be an advertorial, an Evetorial™ advertisement, a tutorial, an interview with a professional in the field of the product or service and/or an electronic catalog. In various embodiments, as used herein, the term “Evetorial™ advertisement” means advertising content that is electronic in form and having characteristics of an editorial. By way of example, but not limitation, an Evetorial™ advertisement may include an electronic editorial about a product or service. In some embodiments, the Evetorial™ advertisement may also include advertising content.

In some embodiments, the supplemental content may be news content. The news content may include information about an event in a geographical proximity that is local to the recipient. In various embodiments, geographical proximities that are local to the recipient may be within 5-10, 11-25 and/or 26-50 miles of the recipient.

In some embodiments, the news content may include information about an event in a geographical proximity that is remote from the recipient. In various embodiments, geographical proximities that are remote from the recipient may be information about an event within a state, nation or county in which the recipient is located or information about an event outside of a state, nation or county in which the recipient is located.

In various embodiments, the supplemental content may be indicia associated with at least one of the intended recipients. By way of example, but not limitation, the indicia may be a sports team logo of a sport team with which at least one of the one or more intended recipients is associated. In another embodiment, the indicia may be a visual likeness of at least one of the intended recipients. In some embodiments, the visual likeness may be a photograph sponsored by at least one of the advertisers associated with advertising content.

In some embodiments, the computer system 140 may select from different supplemental content that the computer system 140 may access. For example, the computer system 140 may access a plurality of advertising content stored in advertisement databases 160, 170, and select advertising content from the advertising databases 160, 170. In other embodiments, the computer system 140 may access other sources of information to select other types of information based on the type of supplemental content for which the computer system 140 has received information. For example, the computer system 140 may receive information about video content and/or news content types of supplemental content and may obtain the video content and/or the news content from sources of such information. In these embodiments, the selection may be based on one or more of: the information received by the computer system 140 that may be indicative of the supplemental content.

In some embodiments, the selection may be based on the characteristics or identity of at least one of the intended recipients of the electronic message and/or the affiliation between an association and the intended recipients of the electronic message. Accordingly, in various embodiments, the computer system 140 may select content and/or placement of the same automatically based on the intended recipients and/or the affiliation between the association and the intended recipients and/or the user may select content or placement of the same manually.

Referring back to FIG. 1, the sender of the electronic message may be a user of the input mechanism 110 and the recipient of the electronic message may be a user of one of the reception mechanisms 120, 130. In some embodiments, the sender may be an association and the recipient may be a constituent of the association. In some embodiments, the constituent of the association may be a coach, a team, a parent, a team player or a shopper. In some embodiments, a team player may be prohibited from being a direct intended recipient of the electronic shell and the parent of the team player may receive all electronic shells for the player. In these embodiments, the parent may provide the player access to the electronic shell upon determining that the player should receive access. Accordingly, in some embodiments, the system may aid parents in protecting minors from exposure to unwanted electronic content or electronic content intended for a parent of a player but not the player.

By way of example, but not limitation, an association may include, any organization, including, but not limited to, a sports-related organization, a retail organization, a not-for profit organization, a political organization, a social networking organization and/or clubs, generally. In some embodiments, the association may be any organization with over a half million constituents. In some embodiments, the association with which the constituent may be affiliated may be any sports league. The sports league may be a sports league based inside or outside of the United States, and/or an international sports league. In some embodiments, for example, the sports league may be one wherein the associated sporting events are primarily played outside of the United States. In one embodiment, the sporting events may be primarily played in Europe.

By way of further example, but without limitation, a constituent may include a parent of a player affiliated with a sports team, a sports team, a coach or a player affiliated with the organization; a potential or actual buyer of products or services offered by an organization; and/or a potential or current member of an organization.

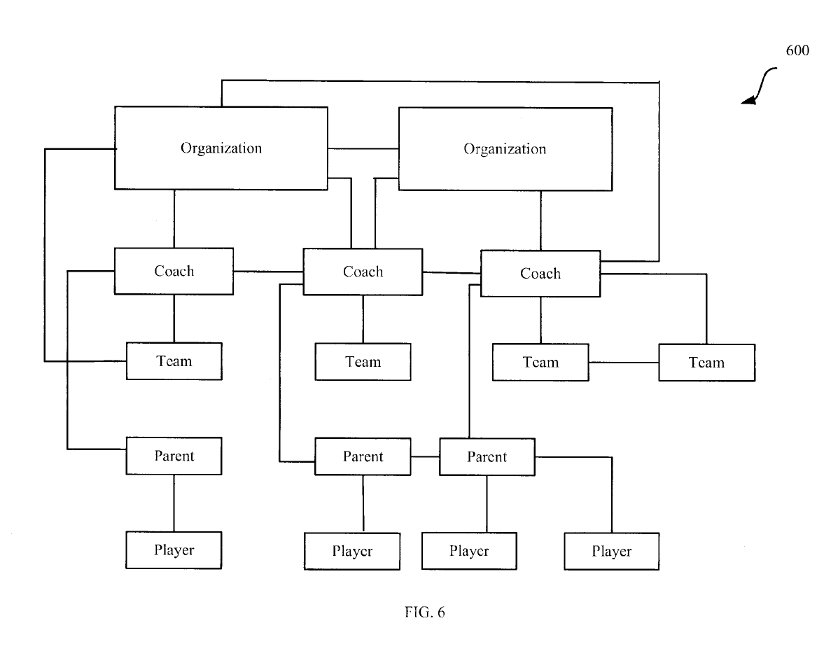

FIG. 6 is a chart illustrating exemplary affiliations between associations and constituents of the associations according to an embodiment of the invention. In FIG. 6, a constituent is shown connected to an association. Generally, any first person or entity having an affiliation with a second person or entity may be either an association or constituent of the second person or entity. The affiliation may be indicated by any number of scenarios including but not limited to, a formal membership structure, an advertiser-audience relationship, and/or any first person o entity and second person and entity having a similarity in goals, interests, products and/or services.

For example, an organization may be considered to be an association and a coach or a sports team may be considered to be a constituent of the association; a coach may be considered to be an association and a sports team, a parent of a player on a sports team and/or another coach may be considered to be a constituent of the association; a sports team may be considered to be an association and another sports team may be considered to be an association.

By way of specific examples, but not limitation, the association may be the National Football League® association and/or the constituent may be a Pop Warner® football team; the association may be the National Football League® association and/or the constituent may be an American Youth Football® team; the association may be the Major League Soccer® association and/or the constituent may be a U.S. Youth Soccer® team; the association may be the U.S. Lacrosse® association and/or the constituent may be a Youth Lacrosse U.S.A.® team; the association may be the Major League Baseball® association and/or the constituent may be a Little League® team; and/or the association may be the European Soccer league and/or the constituent may be a youth sports team affiliated with a sport of the association.

Again, referring to FIG. 1, the input mechanism 110 may be any number of devices that may be configured to receive inputs from a user and transmit the received inputs to the computer system 140. The input mechanism 110 may be any hardware or software mechanism, or combination thereof, configured to receive information for generating content for an electronic message, selecting supplemental content that may accompany the electronic message and/or identifying the sender and one or more intended recipients of the electronic message. The input mechanism 110 may also be configured to display graphical and/or textual information on the input mechanism 110. By way of example, but not limitation, in various embodiments, the input mechanism 110 may be a cellular telephone, a personal computer, a laptop, a keyboard communicatively coupled to the computer system 140 or a personal digital assistant. Accordingly, the input mechanism 110 may be located at a proximity that is local to or remote from the computer system 140.

The reception mechanisms 120, 130 may be any number of devices that may be configured to receive from the computer system 140 the electronic shell, and display the electronic message and the supplemental content of the electronic shell. By way of example, but not limitation, the reception mechanisms 120, 130 may be a computer having a display screen or a cell phone or a personal digital assistant having a display screen.

The computer system 140 may format an electronic shell including the electronic message and the supplemental content such that the electronic message may be displayed with the supplemental content. In some embodiments, the electronic shell may be formatted such that the supplemental content frames one or more sides of the electronic message.

The computer system 140 may prepare the electronic shell to be transmitted to the intended recipients and/or transmit the electronic shell to the intended recipients.

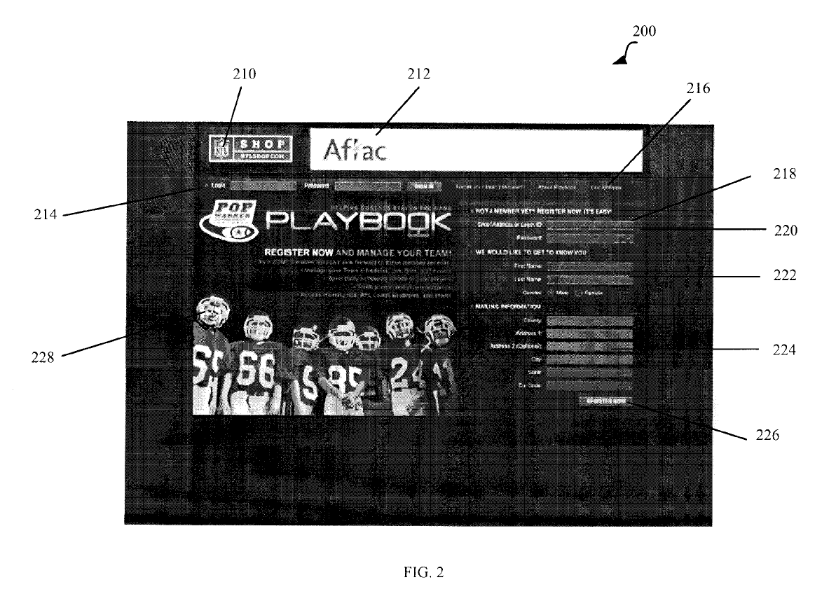

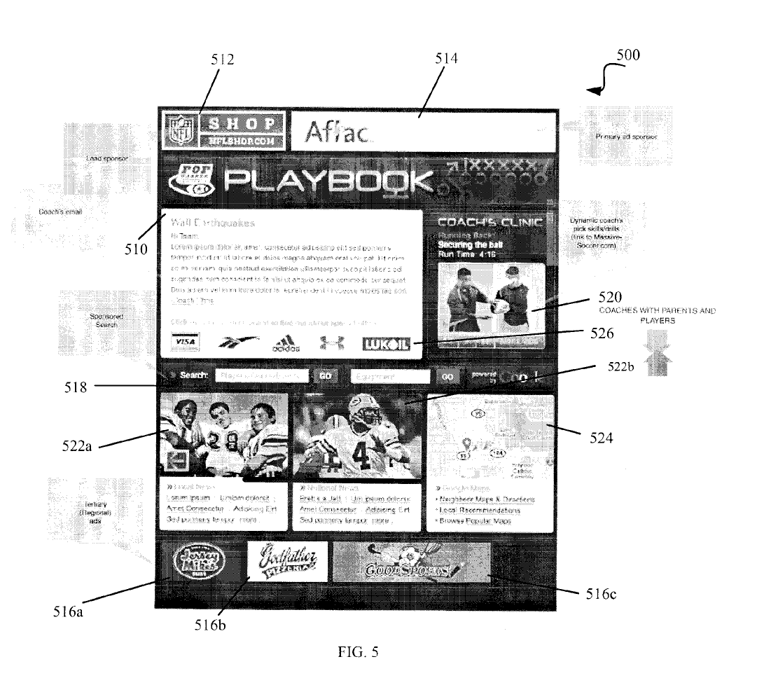

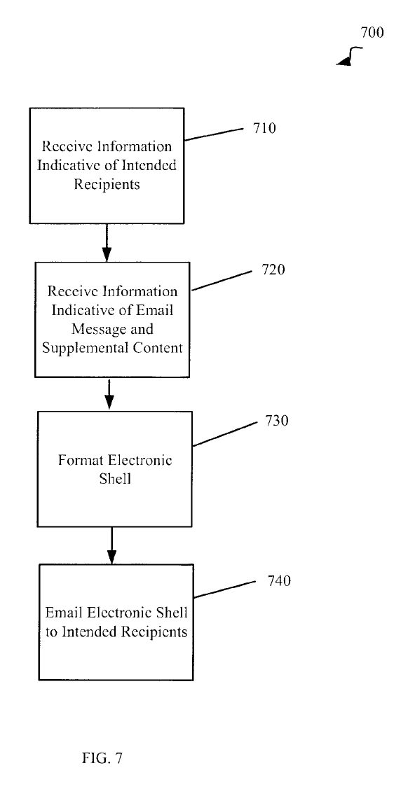

FIGS. 2, 3 and 4 illustrate screen shots of web pages for formatting an electronic shell in a system for association-based electronic message communication according to an embodiment of the invention. FIG. 5 is a screen shot of a web page illustrating an electronic shell according to an embodiment of the invention. FIG. 7 is a flow chart of a method of operation of a system for association-based electronic message communication according to an embodiment of the invention. The method 700 will be described with reference to FIGS. 1, 2, 3, 4, 5, 6 and 7.

In some embodiments, method 700 may be initiated upon the receipt of information. The information may be received at the computer system 140. In some embodiments, the computer system 140 may include a web server (not shown) configured to provide a web page at which the information may be received and which serves web pages in response to the received information.

In some embodiments, the information may be login or registration information that may be received at one or more web pages of a web site with which an association and/or constituents of an association are affiliated. The web site may be an on-line portal configured to provide various functionality, including, but not limited to, facilitating electronic message communication, providing electronic calendaring functions, providing access to third-party advertiser web sites. Accordingly, in various embodiments, the web pages may include any content related to the association; actual or potential constituents of the association; goals or interests of the association or its constituents; and/or advertisements, products, services and/or instructional information of interest to the association or its constituents. Additionally, in various embodiments, the arrangement of the content may vary. All such content and/or arrangements of content are envisaged and within the scope of the embodiments described herein.

FIG. 2 illustrates a screen shot of an embodiment of an initial web page provided for formatting an electronic shell. The web page 200 may include selected advertising content 210, 212, a login section 214, a registration section 218. In some embodiments, the web page 200 may also include onscreen indicia for displaying information about affiliates associated with the one or more intended recipients 216 and/or an image 228 indicative of the association and/or a constituent of the association.

In the login section 214, the web page 200 may include text boxes for receiving login information. To log in, the user may enter a login and a password. To register, the user may enter information into a first text entry section 220, a second text entry section 222 and/or third text section 224. In some embodiments, the user may enter a login and password into the first text entry section 220, a name and gender information in the second text entry section 222 and/or mailing information in a third text entry section 224. The user may activate onscreen indicia 226 for submitting the login or registration information to the computer system 140.

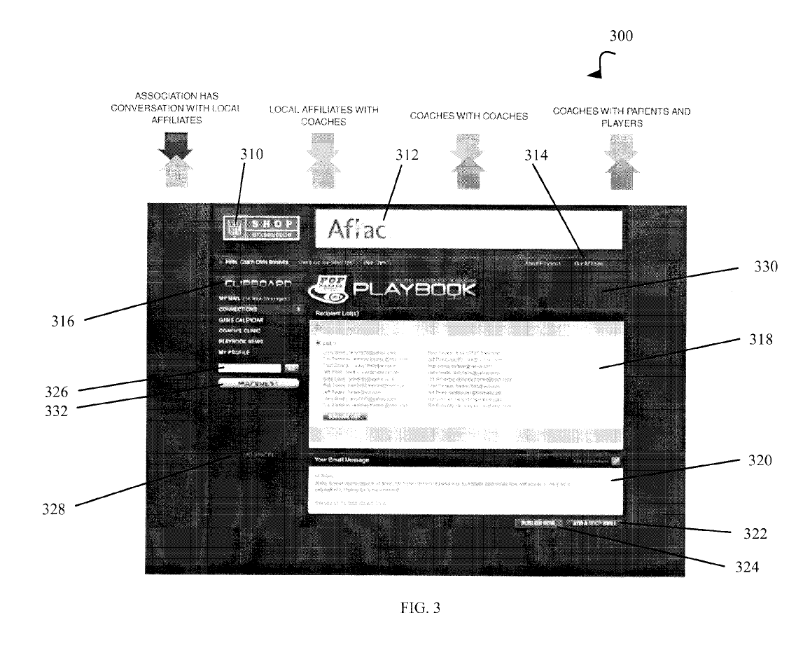

In response to receiving accurate login information or acceptable registration information, the computer system 140 may allow the user to enter the portal and may display a web page 300 such as that shown in FIG. 3. In response to successfully logging in or registering, the web page 300 may be provided.

The web page 300 may include selected advertising content 310, 312, 330 and/or ad space 328 for providing advertisement on a time-limited or other basis. For example, an advertiser may pay an advertising fee to have its selected advertising content displayed on web page 300 and viewed by the user upon the user entering the portal. The web page 300 may also include indicia 326 of an internet search box for receiving text for searching the internet or for searching another data source. The indicia 326 may be sponsored by a particular advertiser in some embodiments. The web page 300 may also include indicia 332 for activating a geographical navigation query.

The web page 300 may also include indicia 316 of a menu of functions that may be performed by a user accessing the web page 300. By way of example, but not limitation, the web page 300 may display a virtual clipboard having menu selections associated with identifying a list of recipients of an electronic shell that may be formatted through the process of method 700; formatting an electronic message; selecting intended recipients of an electronic message; viewing a calendar (e.g., a sports team calendar, a personal calendar); selecting information from a virtual clinic to be displayed with an electronic message to the recipients; selecting information from a virtual playbook; and/or viewing a profile associated with the user.

Referring to FIGS. 3 and 7, upon providing web page 300, in some embodiments, the first step in method 700 may include receiving information indicative of intended recipients of an electronic shell 710. The intended recipients may be identified by name, electronic message address or other characteristic related to a membership of and/or a past purchasing history of the recipient. In some embodiments, the intended recipients may be identified by a selected affiliation to the association. Accordingly, all persons have a selected relationship with the association may be identified as a recipient.

In some embodiments, the information indicative of the intended recipients may be received in response to a user activating the indicia 316 to access a menu from which intended recipients may be selected, and selecting the intended recipients. In some embodiments, the information indicative of the intended recipients may be received in response to a user typing the information into text box 318. The selected recipients may be displayed in text box 318.

In some embodiments, the user may activate the indicia 314 for identifying the persons or entities affiliated with the one or more intended recipients.

In step 720, information indicative of an electronic message and supplemental content to be displayed with the electronic message as part of the electronic shell may be received. The portion of the information indicative of the electronic message may include text and/or graphics corresponding to the content of the electronic message. The information may be entered at text box 320.

In various embodiments, the information received may be indicative of sending an electronic message from: an association to one or more local affiliates; one or more local affiliates to one or more coaches of sports teams; one or more coaches to one or more coaches; and/or one or more coaches to one or more parents and/or players of a sports team. As used herein, “affiliate” means a constituent of an association.

Referring to FIGS. 1, 3 and 4, the information indicative of the supplemental content may also be received in step 720. The user may immediately publish the electronic message by activating indicia 324. In other embodiments, the user may publish the electronic message after adding selected supplemental content to the electronic message by activating indicia 322.

The user may manually select the supplemental content to be displayed in the electronic shell and/or the placement of the supplemental content. In some embodiments, the computer system 140 automatically selects the content and/or the placement of the supplemental content. The computer system 140 may select the content and/or the placement of the supplemental content based on one or more factors. The factors may include, but are not limited, whether the supplemental content is associated with a sponsor and/or a key advertiser, the advertising fee paid by the advertiser, the CPM associated with the advertising content, a timeline for which the advertising content is valid or requested, the region to which the supplemental content is directed, one or more terms of a particular advertiser agreement, the intended recipients of the electronic shell and/or an affiliation between the intended recipients and a selected association. In some embodiments, the computer system 140 may include or have access to information indicative of one or more of the above factors and access such information upon receiving information indicative of requesting supplemental content be added to an electronic shell. In response to receiving the information indicative of the request, the computer system 140 may automatically select content and/or the placement of content based on one or more of the above factors. In accordance with other embodiments, the computer system 140 automatically selects the content and/or the placement of the supplemental content according to a predetermined event such as a calendar entry or a specified time (i.e., day of the week, time of day, etc.). The computer system 140 may also select the content and/or the placement of the supplemental content based on such predetermined timing (date and time) alone or in combination other factors. These other factors may include, but are not limited, whether the supplemental content is associated with a sponsor and/or a key advertiser, the advertising fee paid by the advertiser, the CPM associated with the advertising content, a timeline for which the advertising content is valid or requested, the region to which the supplemental content is directed, one or more terms of a particular advertiser agreement, the intended recipients of the electronic shell and/or an affiliation between the intended recipients and a selected association. In some embodiments, the computer system 140 may include or have access to information indicative of one or more of the above factors and access such information upon receiving information indicative of requesting supplemental content be added to an electronic shell. In response to receiving the information indicative of the request, the computer system 140 may automatically select content and/or the placement of content based on one or more of the above factors.

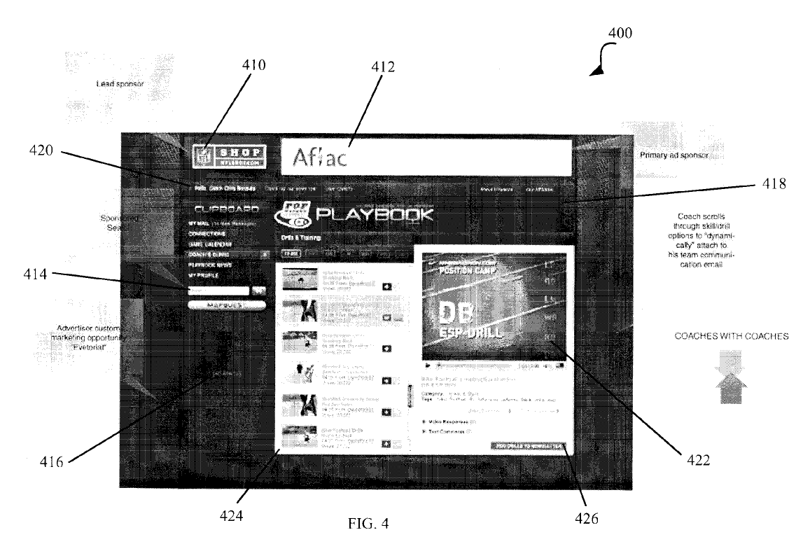

For example, supplemental content may be selected at a web page such as that shown in FIG. 4. As with web page 300, web page 400 may include selected advertising content 410, 412, 418, sponsored searches 414, and advertisement space 416 that may be obtained by an advertiser. The web page 400 may also include information about the user 420. The web page 400 may also include a menu for selecting supplemental content to add to an electronic shell. For example, activating the “Coach's Clinic” indicia may result in a display of video content that may be selected for inclusion in the electronic shell. The video content may be selected from a number of videos 424 and displayed for viewing in display region 422. In the embodiment shown, the user may be a coach that may scroll through skill/drill options to dynamically attach a video to an electronic shell intended for his sports team. Upon entry of information indicative of the supplemental content, the user may activate indicia 426 for adding the video content to the electronic shell.

In step 730, the electronic shell may be formatted with the electronic message and the supplemental content. The electronic shell may be formatted such that the electronic message is displayed simultaneously with the supplemental content.

FIG. 5 is a web page illustrating exemplary content for and arrangement of an electronic shell. The electronic shell 500 may include selected advertising content from a sponsor 512, selected advertising content from a key advertiser 514, an electronic message from a coach to sports team intended recipient 510, a contextual advertising content 520, an electronic map 524, a sponsored internet searching text box 518, local news content 522a and national news content, selected advertising content from a geographic region that is within a proximity that is regional to the recipient 516a, 516b, 516c and/or contextual advertising content 526. In the embodiment shown, the video tutorial 520 may be contextual advertising content because the video content includes embedded selected advertising content by way of the Nike® shirts worn by the persons in the video. As shown in FIG. 5, the supplemental content, which includes the information indicated at 512, 514, 516a, 516b, 516c, 518, 520, 522a, 522b, 524, 526, may frame at least a portion of the electronic message 510.

Referring back to FIG. 7, the method 700 may also include initiating the transmission of the electronic shell to the intended recipients 740. The transmission may be performed such that the intended recipient may view the electronic shell as displaying both the electronic message simultaneously with the supplemental content. For example, referring to FIG. 5, the intended recipients may view the electronic shell as shown in FIG. 5 upon opening the electronic shell sent to the intended recipients. In accordance with various embodiments of the present invention, the electronic shell may be transmitted by the user by manually activating transmission or the electronic shell may be transmitted automatically. In accordance with various embodiments of the invention, the electronic shell may be transmitted automatically at one or more predetermined times or at the occurrence of one or more pre-designated events. For example, the electronic shell may be automatically transmitted to an intended recipient on one or more specified days of the week at one or more specified times, without limitation. As another example, the electronic shell may be automatically transmitted to an intended recipient based on proximity to an upcoming game or practice, for instance, the electronic shell may be automatically transmitted the night before a practice or a game. As noted above, the content of the automatically transmitted shell may be adjusted based on a variety of factors, including but not limited to an upcoming game, practice schedule, a particular team to be played in a game, geographic occurrence of the game or where opposing team is from, pre-game or pre-practice weather reports, field condition reports, the outcome of a game (i.e., win, loss or tie), cancellation or rescheduling of a game or practice, adjustments to practice or game schedules, travel plans and the like, without limitation. As such, the system may be programmed to automatically provide recurring messages according to a routine schedule, a variable schedule, or in response to events, with or without further input from the user. Further, the automatically provided messages may be adapted to the timed messages, such that, for example, the content changes depending on when the message is sent and/or according to the nature of one or more events, such as for example a change in schedule of practices, a change in game schedule, a game outcome, a weather change, etc. According to various embodiments, the automated functionality of a message transmission is interactive with one or more internal databases, such as for example, a database directed to calendar data, practice schedule date, game schedule data, game outcome data. According to various embodiments, the automated functionality of message transmission is interactive with one or more external databases, such as a database directed to weather data, field data, purchase data, advertising data and the like. For instance, the systems may be programmed to contain a variety of alternative preprogrammed messages or content that each correspond to particular events. For example, a change in weather could trigger a change in content or add a message or content advising regarding weather prior to a game. In accordance with other embodiments, one or more preliminary messages containing a link to the communications network or computer system, such as a website, may be automatically transmitted to a user, such an organization, coach, team, and the like. The preliminary messages may be timed in the same manner as the electronic shell is timed for automatic transmission as described above, for example, such messages may be timed at a predetermined day and time or triggered by a pre-designated event. The preliminary message, for example, would provide an electronic message containing a link to the website to a coach on the eve of a game so that the coach could prepare or adapt an electronic shell for transmission to parents of team members. The preliminary message may also be interactive with external websites. For example, a weather advisory or field condition report from external databases or websites and the like may trigger a preliminary email with a link to the system's website to facilitate a coach generating an appropriate electronic message.

The electronic shell has been primarily described with regard to FIG. 5. However, the electronic shell may include other indicia and functionality for enhancing the experience or ease of use of a user and/or an intended recipient. For example, the electronic shell may display indicia that may be activated to enable a user and/or an intended recipient to connect to another web page or web site and/or a landing page. In various embodiments, the web page may be a micro site affiliated with an association (e.g., sports league), while the web sites and web pages generally, may include information related to local, regional, national, countrywide or international topics of interest including, but not limited to, community message boards, neighborhood classified advertisement information or otherwise. The electronic shell may include buttons, scroll bars, links, knobs, preset indicia, indicia that may be created by the user or any other indicia for interfacing with the electronic shell and/or other web pages or web sites.

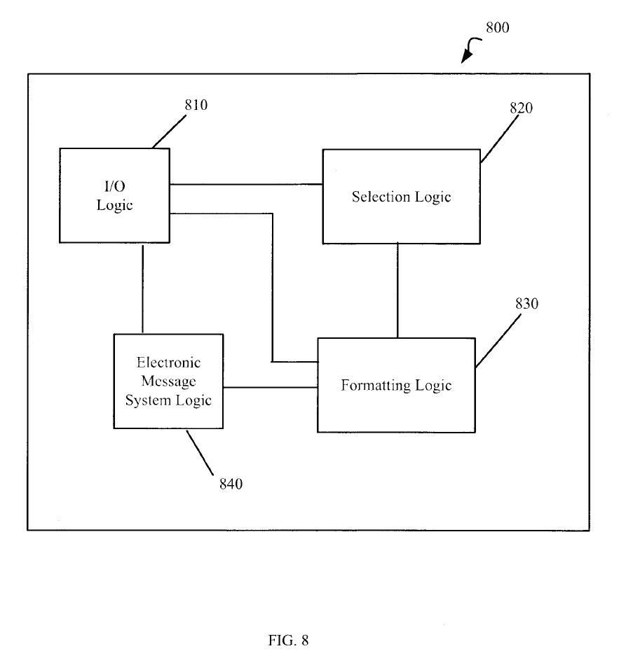

FIG. 8 is a block diagram of logic of a computer system for association-based electronic message communication according to an embodiment of the invention. The computer system 800 may perform the steps of the method described with reference to FIG. 7.

In some embodiments, as shown, the computer system 800 may include an Input/Output (“I/O”) logic 810, selection logic 820, formatting logic 830 and electronic message system logic 840. The I/O logic 810 may be communicatively coupled to the selection logic 820, the formatting logic 830 and the electronic message system logic 840. The selection logic 820 may be communicatively coupled to the formatting logic 830. The formatting logic 830 may be communicatively coupled to the selection logic 830 and the electronic message system logic 840. The electronic message system logic 840 may be communicatively coupled to the I/O logic 810 and the formatting logic 830.

The I/O logic 810 may receive the information indicative of the intended recipients, the electronic message and/or the supplemental content. The information received at the I/O logic 810 may be received at the selection logic 820. The selection logic 820 may be configured to select supplemental content and/or intended recipients based on the information received at the I/O logic 810 in some embodiments.

In other embodiments, the selection logic 820 may be configured to automatically select supplemental content and/or intended recipients independent of any information received at the I/O logic 810. For example, the supplemental content and the intended recipients may be pre-programmed into computer system 800 such that upon a user logging in or registering the electronic shell is formatted with pre-programmed supplemental content and/or intended recipients. The pre-programmed selection may be based on the identity of the user in some embodiments.

Referring back to FIG. 8, the formatting logic 830 may be configured to format an electronic shell including an electronic message and supplemental content indicated by the information received at the I/O logic 810 and received at the formatting logic 830 from the I/O logic 810. The electronic message system logic 840 may receive the electronic shell and transmit the electronic shell to the intended recipients via the I/O logic 810.

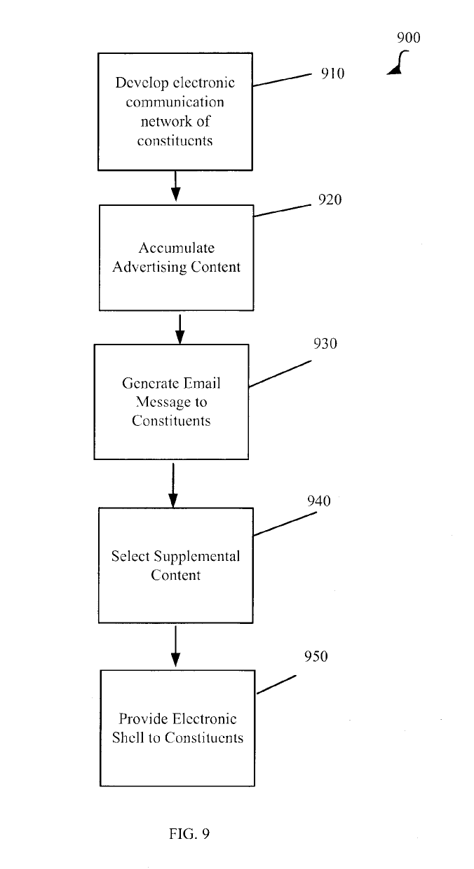

FIG. 9 is a flow chart of a method of operation of a system for association-based electronic message communication according to another embodiment of the invention. The method 900 may include developing an electronic communication network of one or more constituents affiliated with an association 910. In step 920, advertising content may be accumulated from advertisers. The advertising content may include a graphical image. The advertising content may be targeted at one or more of the constituents. In some embodiments, the advertising content may represent tiers of advertising such as that described with reference to FIG. 1.

The method 900 may also include generating an electronic message to selected ones of the one or more constituents 930. In various embodiments, the constituents are the intended recipients of the electronic message. Generating the electronic message may be performed at a website with which the one or more constituents are associated. In some embodiments, the website may include web page 300 described with reference to FIG. 3.

The method 900 may also include selecting supplemental content 940. Selecting the supplemental content may be performed at a website with which the one or more constituents are associated. In some embodiments, the website may include web page 400 described with reference to FIG. 4.

In some embodiments, the selected advertising content may be selected independently of a content of a body of the electronic message. In some embodiments, the selected advertising content may be selected based on an identity of at least one of the constituents. In some embodiments, the selected advertising content may be selected based on a preference of at least one of the constituents. In some embodiments, the selected advertising content may be selected based on an affiliation between a sender of the electronic message, or an association, and at least one of the constituents of an association.

Referring back to FIG. 9, the method 900 may also include providing to the selected ones of the one or more recipients, an electronic shell 950. In some embodiments, the electronic shell may include the supplemental content framing at least a portion of the electronic message. The electronic shell may be provided to be displayed as shown in FIG. 5.

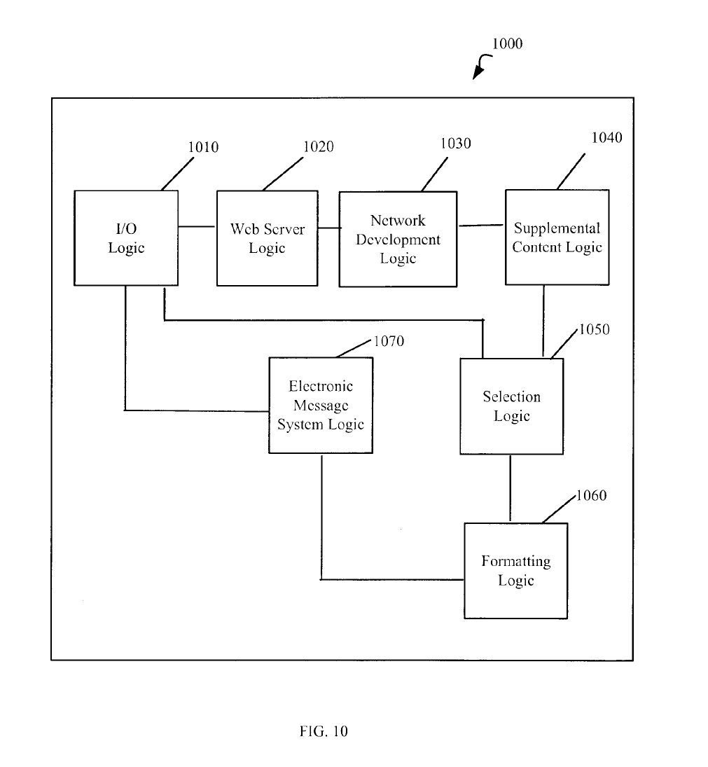

FIG. 10 is a block diagram of logic of a computer system for association-based electronic message communication according to an embodiment of the invention. The logic of the computer system may be used in conjunction with an input mechanism and a receiving mechanism such as input mechanism 110 and receiving mechanism 120, 130 of FIG. 1.

The computer system 1000 may include I/O logic 1010, web server logic 1020, network development logic 1030, supplemental content logic 1040, selection logic 1050, formatting logic 1060 and/or electronic message system logic 1070. The I/O logic 1010 may be communicatively coupled to the web server logic 1020, the selection logic 1030 and the electronic message system logic 1070 for transmitting information received at the I/O logic 1010 to each of the aforementioned logic blocks to which it is communicatively coupled. The web server logic 1020 may be communicatively coupled to the I/O logic 1010 and the network development logic 1030. The network development logic 1030 may be communicatively coupled to the supplemental content logic 1040. The supplemental content logic 1040 may be communicatively coupled to the selection logic 1050. The selection logic 1050 may be communicatively coupled to the formatting logic 1060 and the I/O logic 1010. The formatting logic 1060 may be communicatively coupled to the selection logic 1040 and the electronic message system logic 1070. The electronic message system logic 1070 may be communicatively coupled to the I/O logic 1010 and the formatting logic 1060.

The I/O logic 1010 may be configured to receive information for developing an electronic communication network of one or more constituents affiliated with an association. By way of example, but not limitation, the I/O logic 1010 may receive information about an association and identifying information and/or contact information (e.g., electronic message addresses) of the constituents of the association.

The network development logic 1030 may be configured to receive from the I/O logic 1010 information indicative of an association and/or constituents of an association. The network development logic 1030 may be configured to develop a network by affiliating associations and constituents. In some embodiments, the network development logic 1030 may develop a virtual chart of a network between the associations and the constituents such as that shown in FIG. 6. The network developed with the network development logic 1030 may allow a user of the system accessing a web page such as that shown on FIG. 3 to retrieve a list of intended recipients based on an affiliation with an association. The network development logic 1030 may retrieve information about a constituent. The constituent may be selected as an intended recipient of the electronic shell.

The supplemental content logic 1040 may obtain or accumulate supplemental content to be included in an electronic shell with the electronic message. The supplemental content may include, but is not limited to, advertising content, video content, news content, internet search content, geographical navigation content (e.g., content for generating electronic maps) and/or instant messaging content.

In some embodiments, the supplemental content may be advertising content from one or more advertisers. Some of the advertising content may be of interest to one or more constituents identified with the network development logic 1030. In some embodiments, the supplemental content logic 1040 may receive from the network development logic 1030 information indicative of the constituents and accumulate advertising content targeted to the constituents.

In some embodiments, the supplemental content logic 1040 may categorize the advertising content according to one or more of the following to determine whether advertising content selected for inclusion in an electronic shell is appropriate for inclusion: an identity of an appropriate constituent; and/or an affiliation between the user (or association represented by the user) and the constituent.

The I/O logic 1010 may also be configured to receive information for initiating the formation of an electronic shell. The web server logic 1070 may be configured to receive the information received at the I/O logic 1010 and provide one or more web pages to a user for formatting an electronic shell. For example, with reference to FIGS. 2, 3 and 4, the web server logic 1070 may provide web pages 200, 300, 400 for formatting the electronic shell.

The selection logic 1050 may receive the information indicative of the supplemental content. The information may be submitted at the web page provided by the web server logic 1070.

The selection logic 1050 may access supplemental content via the supplemental content logic 1040. The selection logic 1050 may select the supplemental content based on the information received by the user at the I/O logic 1010, the identity or characteristics of the intended recipient and/or the association between the sender and the intended recipient and/or any other association. In some embodiments, the selection logic 1050 may select the supplemental content independent of the content of the electronic message. In embodiments wherein the supplemental content that is selected is advertising content, the selected advertising content may be associated with one or more geographical tier of advertising, one or more levels of sponsorship and/or types of advertisement or sponsorship (e.g., contextual advertising content, sponsored searches, team names, etc.). Numerous examples of the types of supplemental content that may be selected are illustrated in FIG. 5.

The formatting logic 1060 may receive the selected supplemental content and the information indicative of the electronic message and format an electronic shell. The electronic shell may include the electronic message and supplemental content.

The electronic message system logic 1070 may receive the electronic shell from the formatting logic 1060 and transmit the electronic shell, via the I/O logic 1010 of the computer system 1000 to the one or more intended recipients. In various embodiments, the intended recipients may be constituents included in the network of the network development logic 1030. With reference to FIGS. 1 and 10, in some embodiments, the electronic shell may be received by a user of one of the reception mechanisms 120, 130.

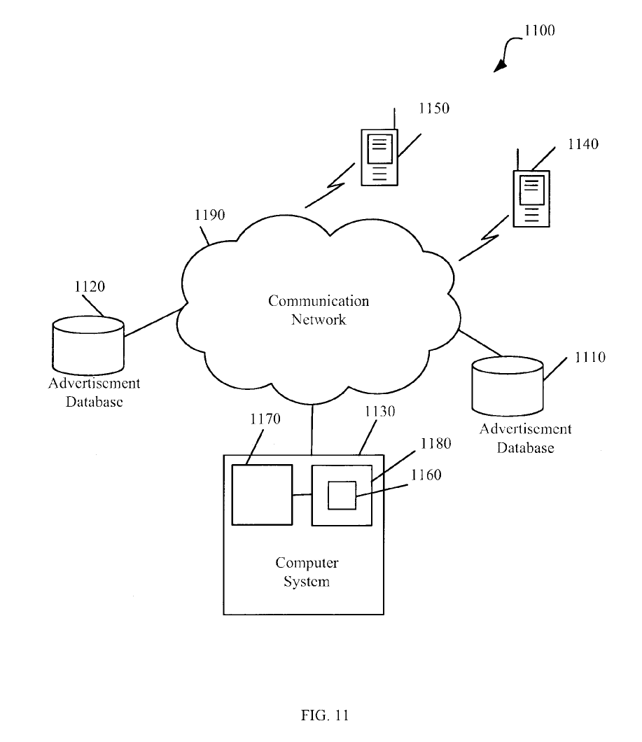

FIG. 11 is a schematic diagram of a system for association-based electronic message communication according to another embodiment of the invention. In some embodiments, the system 1100 may include one or more advertisement databases 1110, 1120 having a plurality of advertising content representing at least one tier of advertising. The system 1100 may also include a computer system 1130 communicatively coupled to the one or more advertisement databases 1110, 1120 and to at least two communication devices 1140, 1150. The computer system 1130 may include a special purpose computer. The special purpose computer may be configured to format an electronic shell.

The computer system 1130 may include a computer program having a plurality of instructions 1160, a processor 1170 and a computer readable medium 1180 on which the plurality of instructions are stored. The instructions may be for receiving information indicative of an electronic message, one or more intended recipients of the electronic message and supplemental content. The information may be received over a communication network 1190.

The supplemental content may be advertising content selected from the plurality of advertising content in the one or more advertisement databases. The selected advertising content may represent at least one tier of advertising. The instructions may be also for formatting an electronic shell including the electronic message associated with the information indicative of the electronic message, and the selected advertising content associated with the information indicative of the supplemental content. The electronic shell may be formatted to display the electronic message with the selected advertising content. The instructions may be also for transmitting the electronic shell to the one or more intended recipients. In some embodiments, the system also includes the two communication devices.

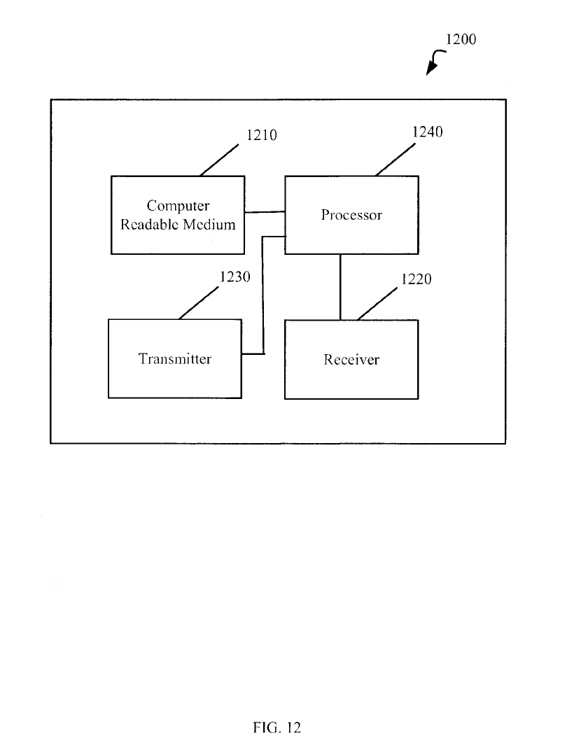

FIG. 12 is a block diagram of a device having a computer readable medium according to an embodiment of the invention. In various embodiments of the invention, the computer readable medium 1210 of the device 1200 may be provided to perform one or more of the aspects of the invention described herein. In some embodiments, the computer readable medium 1210 may include any number of materials for storing one or more computer programs (not shown) and may be magnetic.

In some embodiments, the computer readable medium 1210 includes a computer program stored on the computer readable medium 1210 and being accessed for controlling the device 1200 according to instructions of the computer program.

In some embodiments, the device 1200 may also include a receiver 1220, a transmitter 1230 and a processor 1240. The receiver 1220 may be controlled to receive signals indicative of an electronic message, one or more intended recipients of the electronic message, and supplemental content. The signals (not shown) may be electrical and/or optical in nature. The receiver 1220 and the transmitter 1230 may be designed to receive and transmit, respectively, the electrical, infrared and/or optical signals. The supplemental content may be advertising content selected from the plurality of advertising content in the one or more advertisement databases. The selected advertising content may represent at least one tier of advertising.

In response to receiving the electronic message and the supplemental content, the processor 140 of the device 1200 may be controlled to format an electronic shell including the electronic message and the selected advertising content. The electronic shell may be formatted to display the electronic message with the selected advertising content.

In response to formatting the electronic shell, the transmitter 1230 of the device 1200 may be controlled to transmit to the one or more intended recipients signals indicative of the electronic shell. The signals may be electrical, infrared and/or optical in nature.

The present invention contemplates using the various system, devices, methods and computer readable mediums alone or in conjunction with other electronic and/or non-electronic communications, including other electronic and/or non-electronic advertising media. The present invention also contemplates using any electronic mail system and the like, including any system that delivers an electronic message via a computer-based system to intended recipients, or recipients generally.

Additionally, with particular reference to FIG. 1, the present invention contemplates devices, including, but not limited to, embodiments of input mechanism 110, reception mechanisms 120, 130 and/or computer system 140 or components thereof. One or more of the devices may include a processor, memory, an input device, and a display.

The memory may be non-volatile in order to retain stored information, should power be temporarily unavailable. In some embodiments, the memory may include, but is not limited to, an EEPROM or a SIM card. One or more of the devices may also include a communication unit and an antenna wherein the communication unit may be communicatively coupled to the antenna. The communication unit may be a radio.

One or more of the devices may further include additional data capture devices. In some embodiments, the device may include a touch screen and a touch sensor that may be used to capture inputs provides at a touch screen. Further, an audio/video capture device may be provided. Audio/video capture device may include a camera and a microphone. The audio/video capture device may capture still images and/or moving images. Audio may be captured alone or in connection with the images. In various embodiments, the devices may include a biometric capture device and/or a GPS tracking device.

One or more of the devices may also include an output device. In one embodiment, the output device may include a printer. In another embodiment, the output device may include a speaker. In one embodiment, the device may also interface with independent output devices via a communication port.

One or more of the devices may be provided with software application. The software application may reside on the device and/or may access software applications. In various embodiments, the software applications may include, but are not limited to, an email program, a calendar, a web browser and/or user authentication applications.

The embodiments disclosed herein also contemplate communication networks of different types. In various embodiments, the communication network may be wireless and/or wired, and may transmit information according to optical, electrical and/or infrared communication. Further, various technologies may be included in the communication network to provide communication. Such technologies used to provide such communication might include a network, the internet, an intranet, an extranet, a local area network (“LAN”), a wide area network (“WAN”), and/or an ethernet network. Such communications technologies may use any suitable protocol such as TCP/IP, for example. By way of example, but not limitation, the communication network may be a General Packet Radio Service (“GPRS”) communication network. Communication towers and/or other relaying devices may be provided as necessary and/or desired to provide communication between one or more of the components communicatively coupled to the communication network. In some embodiments, the communication network may be a satellite communication network. Other types of communications networks may be used as necessary and/or desired.

Additionally, the present invention contemplates systems, including, but not limited to, computer systems configured for performing the aspects of the invention disclosed herein. In some embodiments, computer system 140 may include a server configured to provide a device push-based access to the electronic shells. In one embodiment, the server may be a Blackberry Enterprise Server. Other servers may be used as necessary and/or desired.

It will be appreciated that the computer system may include programmable devices or a system of devices to implement the foregoing described functionality. The computer system may also include computer programs for controlling the computer system to perform the functionality. The computer programs can be embodied as source code and undergo compilation for implementation on processing devices or a system of devices, or can be embodied as object code, for example. Those of ordinary skill will readily understand that the terms “computer” and “computer system” in their most general sense encompass programmable devices, data processing apparatus and the like.

In some embodiments, the computer programs are stored on carrier media in machine or device readable form, for example in solid-state memory or magnetic memory such as disk or tape, and processing devices utilize the programs or parts thereof to configure themselves for operation. The computer programs can be supplied from remote sources embodied in communications media, such as electronic signals, radio frequency carrier waves, optical carrier waves and the like. Such carrier media are also contemplated as aspects of the present invention.

The computer system or portions of the computer system of the invention may be in the form of a “processing machine,” such as a general purpose computer, for example. As used herein, the term “processing machine” includes at least one processor that uses at least one memory. The at least one memory stores a set of instructions. The instructions may be either permanently or temporarily stored in the memory of the processing machine. The processor executes the instructions that are stored in the memory or memories in order to process information. The set of instructions may include various instructions that perform a particular task or tasks, such as those tasks described with reference to the figures. Such a set of instructions for performing a particular task may be characterized as a program, software program, or simply software.

As noted above, the processing machine executes the instructions that are stored in the memory to process information. This processing of information may be in response to requests and/or commands received at the processing machine. As noted above, the processing machine used to implement the invention may be a general purpose computer. However, in various embodiments, the processing machine described above may also utilize any of a wide variety of other technologies including a special purpose computer, a system including a microcomputer, mini-computer, mainframe, a programmed microprocessor, a micro-controller, a peripheral integrated circuit element, a Customer-Specific Integrated Circuit (“CSIC”), an Application-Specific Integrated Circuit (“ASIC”), other integrated circuits, a logic circuit, a digital signal processor, a programmable logic device such as a FPGA, PLD, PLA or PAL, or any other device or arrangement of devices that is capable of implementing embodiments of the invention.

The processing machine used to implement embodiments of the invention may utilize a suitable operating system. Thus, embodiments of the invention may include a processing machine running the Microsoft Windows® Vista® operating system, the Microsoft Windows® XP® operating system, the Microsoft Windows® NT® operating system, the Windows® 2000 operating system, the Unix® operating system, the Linux® operating system, the Xenix® operating system, the IBM AIX® operating system, the Hewlett-Packard UX® operating system, the Novell Netware® operating system, the Sun Microsystems Solaris® operating system, the OS/2® operating system, the BeOS® operating system, the Macintosh® operating system, the Apache® operating system, an OpenStep® operating system and/or another operating system or platform.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example the software used might also include modular programming in the form of object oriented programming. The software may instruct the processing machine as to the data or information being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language may be binary coded machine instructions that are specific to a particular type of processing machine, i.e., to a particular type of computer, for example. The computer system, or component thereof, may understand the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software, for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions, memory card, SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of user interfaces may be utilized to allow a user to interface with the processing machine or machines, devices, and/or computer systems that are used to implement the invention. As used herein, a user interface may include any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface may be any device that provides communication between a user and a processing machine. The information provided by the user to the processing machine through the user interface may be in the form of a command, a selection of data, or some other input, for example.

As discussed above, a user interface may be utilized by the processing machine that performs a set of instructions such that the processing machine processes data for a user. The user interface may typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It is appreciated that in order to practice the embodiments of the invention, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Additionally, the present invention contemplates systems configured for and methods of transmitting the electronic shell between different types of media for various applications. For example, electronic shell to fax, fax to electronic shell, electronic shell to printer, scanner to electronic shell, multicast and narrowcast applications and/or any other applications for providing the electronic shell in one or more different forms and/or between one or more different types of communication systems are envisaged within the scope of the embodiments of the invention. Additionally, by way of example, but not limitation, the media may include paper media, audio media and/or any type of electronic media.

In the preceding specification, various exemplary embodiments have been described with reference to the accompanying drawings. It will, however, be evident that various modifications and/or changes may be made thereto, and/or additional embodiments may be implemented, without departing from the broader scope of the invention as set forth in the claims that follow. The specification and/or drawings are accordingly to be regarded in an illustrative rather than restrictive sense.

What is claimed is:

1. A system comprising:
one or more advertisement databases, the one or more advertisement databases having a plurality of advertising content representing at least one tier of advertising; and
a computer system communicatively coupled to the one or more advertisement databases and to an input mechanism, the computer system being configured to:
receive information indicative of:
an electronic message and one or more intended recipients of the electronic message;
supplemental content, wherein the supplemental content is advertising content selected from the plurality of advertising content in the one or more advertisement databases, the selected advertising content representing at least one tier of advertising;
a predetermined date, time or pre-designated event;
generate an electronic message to a user with a link to the computer system, when prompted by the predetermined date, time or pre-designated event, allowing the user to format an electronic shell comprising the electronic message associated with the information indicative of the electronic message and the selected advertising content associated with the information indicative of the supplemental content, the electronic shell being formatted to display the electronic message with the selected advertising content; and
transmit the electronic shell to the one or more intended recipients.

2. The system of claim 1, wherein information indicative of the predetermined date or time is provided in the form of an electronic calendar or schedule.

3. The system of claim 1, wherein the information indicative of the pre-designated event is provided by an interface to a database external to the computer system.

4. The system of claim 1, wherein the tier of advertising is indicative of: the selected advertising content being provided by a sponsor of the one or more intended recipients or a key advertiser of the one or more intended recipients; a geographical region to which the selected advertising content is directed; or whether the selected advertising content is contextual advertising content.

5. The system of claim 4, wherein the selected advertising content provided by the sponsor or the key advertiser corresponds to a first tier of revenue.

6. The system of claim 4, wherein the selected advertising content is displayed at a top portion of the electronic shell.

7. The system of claim 4, wherein the selected advertising content corresponds to a second tier of revenue when the selected advertising content is contextual advertising content.

8. The system of claim 4, wherein the supplemental content further comprises video content and the contextual advertising content is included in the video content.

9. The system of claim 4, wherein the selected advertising content corresponds to a third tier of revenue when the selected advertising content is directed to a geographical region that is local or regional relative to a location of the one or more intended recipients.

10. The system of claim 4, wherein the selected advertising content is displayed at a bottom portion of the electronic shell or below a fold of the electronic shell.

11. The system of claim 4, wherein the selected advertising content corresponds to a first tier of revenue when the selected advertising content is directed to a geographical region that includes a state, nation or country of the one or more intended recipients.

12. A method of association-based electronic message communication comprising:
developing an electronic communication network of one or more constituents affiliated with an association;
accumulating a plurality of advertising content from a plurality of advertisers, one or more of the accumulated advertising content being of interest to the one or more constituents;
generating an electronic message to a user, said electronic message containing a link to the electronic communications network;
generating for the user an electronic message to selected ones of the one or more constituents when the user activates the link;
selecting supplemental content, wherein the supplemental content is advertising content selected from the plurality of advertising content in the one or more advertisement databases, the selected advertising content representing a plurality of tiers of advertising; and
providing to the selected ones of the one or more constituents, an electronic shell comprising the electronic message and the selected advertising content, the electronic shell being formatted to display the electronic message with the selected advertising content.

13. The method of claim 12, wherein the electronic message generated for the user is generated at one or more predetermined dates and times.

14. The method of claim 12, wherein the electronic message generated for the user is generated in response to a pre-designated event.

15. The method of claim 12, wherein the pre-designated event is a cancellation of a game or practice.

16. The method of claim 12, wherein the plurality of tiers of advertising comprise advertising content directed to a plurality of geographical regions relative to the one or more constituents or a plurality of levels of sponsorship, the tiers of advertising corresponding to tiers of revenue.

17. The method of claim 12, wherein the selected advertising content is selected independently of a content of the electronic message.

18. The method of claim 12, wherein the selected advertising content is selected based on a characteristic of the one or more constituents.

19. The method of claim 12, wherein the selected advertising content is selected based on an affiliation between the association and the one or more constituents.
